(19) United States
(12) Patent Application Publication
(10) Pub. No.: US 2021/0340285 A1
(43) Pub. Date: Nov. 4, 2021

(54) METHOD FOR PRODUCING HYDROGENATED NITRILE RUBBER AND HNBR COMPOSITIONS THEREOF

(71) Applicant: ARLANXEO DEUTSCHLAND GMBH, Dormagen (DE)

(72) Inventors: Karola SCHNEIDERS, Bergisch Gladbach (DE); Sarah DAVID, Dormagen (DE); Susanna LIEBER, Kaiserslautern (DE)

(73) Assignee: ARLANXEO DEUTSCHLAND GMBH, Dormagen (DE)

(21) Appl. No.: 17/262,406

(22) PCT Filed: Jul. 15, 2019
(86) PCT No.: PCT/EP2019/068956

§ 371 Date: Jan. 22, 2021

(30) Foreign Application Priority Data
Jul. 23, 2018 (EP) 18184883.9

(51) Int. Cl. C08C 19/02; C08L 15/00

(52) U.S. Cl. CPC C08C 19/02; C08L 2312/00; C08L 15/005

(57) ABSTRACT

The present invention relates to a method for producing hydrogenated nitrile rubber (HNBR) having good ageing properties in the presence of ruthenium, palladium or rhodium compounds and also to the hydrogenated nitrile rubber produced by this method and HNBR compositions thereof.

This application is a § 371 national stage of PCT International Application No. PCT/EP2019/068956, filed Jul. 15, 2019, which claims foreign priority benefit under 35 U.S.C. § 119 of European Patent Application No. 18184883.9, filed Jul. 23, 2018, the entire disclosures of each of which are incorporated herein by reference.

The present invention relates to a method for producing hydrogenated nitrile rubber (HNBR) having good ageing properties in the presence of ruthenium, palladium or rhodium compounds and also to the hydrogenated nitrile rubber produced by this method and HNBR compositions thereof.

For the production of hydrogenated nitrile rubber (HNBR), i.e. for the hydrogenation of unsaturated nitrile rubber (NBR) to form hydrogenated nitrile rubber, various noble metal catalysts based on metals from the eighth to tenth transition group (8th transition group: Ru; 9th transition group: Rh; 10th transition group: Pd) are typically used. Both homogeneously and heterogeneously catalysed methods are used here. With both method types there is a subsequent, frequently complicated and technically demanding removal or recovery of the catalysts.

While in the case of homogeneous catalysts resin beds are used to remove the noble metals, for example, heterogeneous catalysts are removed by filtration. However, fine solids particles or catalyst that has entered into solution as a result of being washed out cannot be captured in this way, and complete removal additionally requires further complicated method steps.

To date, efforts in the production of hydrogenated nitrile rubber have been primarily directed at using as little expensive catalyst as possible. The use of little catalyst, however, leads to the hydrogenation rate being lower and the production method thus becoming longer in duration and more expensive. Focus has therefore been on the search for improved catalysts having higher activity at equal or even lower catalyst mass.

On account of the high cost of the catalyst, it should be removed as completely as possible after the hydrogenation and recovered as completely as possible. A further reason for removing catalyst residues from the HNBR produced is that catalyst residues cause undesirable dark discolourations in the hydrogenated nitrile rubber produced and thus limit the possibilities for use of the hydrogenated nitrile rubber. Such noble metal residues usually have a negative influence on the product properties, especially on the ageing and the gel content of the hydrogenated nitrile rubber.

On account of the negative properties of the noble metal residues, numerous methods are known from the prior art for removing noble metal residues from the hydrogenated nitrile rubber produced.

The hydrogenation of NBR to form HNBR has been known since the 1970s. Even at that time it was described that the catalysts should be removed from the hydrogenated nitrile rubber.

U.S. Pat. No. 3,700,637 discloses precipitating the HNBR rubber from a chlorobenzene/m-cresol solution with methanol and subsequently successively washing the coagulated rubber with methanol until the methanol is no longer coloured. This is very inconvenient and difficult to carry out on a multi-tonne production scale, since considerable amounts of solvent are involved.

DE-A-2539132 discloses one of the first methods for hydrogenating NBR using Rh catalysts (RhCl(PPh₃)₃), wherein the catalyst can be separated off by the method described in DE1558395, i.e. by a reaction of the Rh-containing mixture with metals such as for example mercury or zinc to give insoluble materials.

EP-A-0482391 discloses the recovery of rhodium and ruthenium catalysts from solutions of hydrogenated nitrile rubber by adsorption on organosiloxane-based absorbers. Here, HNBR having 58-60 ppm of rhodium is subjected to a recovery method.

CN-A-102924726 discloses a method for hydrogenating NBR to form HNBR in which Rh nanoparticle on a carrier having dendrimeric structures is used as catalyst. In order to recover the Rh from the reaction mixture, use is made of salts for regulating ionic strength and also mercaptans in aromatic solvents. Recovery is very important, as Rh is expensive and has a negative influence on the performance of HNBR.

CN-A-101704926 discloses a method for removing noble metal catalysts from HNBR solutions by adding tin-containing complexing reagents. The removal rate is 99%.

CN-A-1483744 requires the recovery of Group VIII noble metals, as they lead to discolourations and poor product appearance, and negatively affect polymer degradation, ageing and product properties as a whole.

CN-A-1763107 discloses the recovery of catalyst metals such as rhodium and ruthenium, since these negatively affect polymer degradation under heat, in the presence of oxygen, under the influence of UV, and also ageing and product performance.

EP-A-1203777 discloses the recovery of Rh catalysts using thiourea-functionalized resins. The removal of catalytically active metals (Fe, Rh) is described as advantageous for reasons of costs and for general product quality.

EP-A-1454924 discloses the hydrogenation of NBR by means of 0.45 parts of magnesium-silicate-supported metal catalyst comprising Pd and also the recovery thereof by means of conventional methods, for example filtration or drying.

Furthermore, methods are known from the prior art for removing heterogeneous noble metal catalysts by means of filtration methods.

EP-A-1524277 describes ultrafiltration as a method for removing noble metal catalysts and residues thereof from polymer solutions.

EP-A-2072532 discloses a method for recovering iron residues and also Rh and/or Ru catalysts from an HNBR solution using functionalized ion-exchange resins.

EP-A-0431370 discloses a method for removing rhodium from an HNBR solution by means of ion-exchange resins comprising a carbodithioate functionality. The purified HNBR copolymers contain 5.8 to 9.2 ppm of Rh.

EP-A-2072533 discloses an HNBR having very low Ru contents, and also the production thereof by removing Ru using functionalized resins.

As a further method for removing noble metals, WO-A-2013/098056 also discloses the use of ionic liquids. In this case, Fe, Ru and Rh inter alia are removed in order to be suitable for medical applications.

WO-A-2016/208320 discloses a method for recovering metal catalysts of the platinum group from HNBR solutions via amino- or thiol-functionalized fibre membranes.

EP 3 081 572 A1 discloses ruthenium and osmium catalysts of the formula (I) that are used for hydrogenating unsaturated hydrates [001].

U.S. Pat. No. 5,128,297 discloses a catalyst having a high-molecular-weight complex formed from a palladium compound and a polymer comprising nitrile groups and conjugated dienes. Hydrogenation is effected with palladium compounds at a content of 1500 or less to 2000 ppm; in Examples 1-3 at a content of 497, 5500, 499, 501, 766 and 1100 ppm, and in Examples 4 and 5 at a content of 500 ppm.

US 2016/0326322 A1 discloses hydrogenated nitrile rubbers (HNBRs) comprising phosphine oxides and/or diphosphine oxides and a defined proportion of halogens. Hydrogenation is effected in Examples 1-6 using tris(triphenylphosphine)rhodium(I) chloride as catalyst.

EP 0 174 551 A2 discloses low-molecular-weight copolymers and covulcanizates produced therefrom. Hydrogenation is effected in Example 1 using tris(triphenylphosphine)rhodium(I) chloride as catalyst.

The hydrogenated nitrile rubbers known from the prior art, depending on the production method and method for removing the catalysts, have different natures and amounts of noble metal residues which impair the ageing of the HNBR. The impaired ageing properties of these HNBR rubbers restrict the use of the HNBR for some applications. One disadvantage of noble metal residues in the HNBR produced is typically that the finished product experiences an increase in the Mooney viscosity and an increase in the gel content over the course of ageing.

Efficient methods for removing and recovering the noble metals lead to a content of rhodium or ruthenium in the hydrogenated nitrile rubber of typically less than 50 ppm and a content of palladium of typically less than 200 ppm.

In the production of the hydrogenated nitrile rubber, i.e. during hydrogenation of the nitrile rubber, sufficiently high catalyst amounts are desired in order to be able to conduct a reaction rapidly and completely. By means of high catalyst amounts, fluctuation in the degree of hydrogenation is prevented and thus less reject material is produced.

The methods of the prior art for removing the noble metals from the HNBR all have the disadvantage that they are very elaborate and complicated in terms of apparatus. The methods are moreover highly inflexible when the hydrogenation catalyst is changed, as in most cases a new method for removing the noble metals is then necessary. In addition, for verifying the completeness of the removal of the noble metals, a final check subsequently needs to be conducted. When using large amounts of hydrogenation catalyst for rapid conduct of the hydrogenation, the methods for removing the noble metals reach their limits of use. The complete removal of the noble metals from a hydrogenated nitrile rubber is time- and energy-consuming and makes the production process for the hydrogenated nitrile rubber immensely more expensive.

There is therefore a demand for dispensing with all method steps for removing the noble metals in order thus to directly produce a hydrogenated nitrile rubber having good ageing properties.

Accordingly, one problem addressed by the present invention is that of providing methods for producing hydrogenated nitrile rubber that result in hydrogenated nitrile rubber having good ageing properties.

A further problem is that of providing a method for hydrogenating NBR using a metal catalyst in order to produce an HNBR having excellent ageing properties, without a method step for removing the noble metals at the end of the hydrogenation reaction.

The solution to the problem, and the subject-matter of the present invention, is a method for producing hydrogenated nitrile rubber (HNBR), wherein at least partially unsaturated nitrile rubber (NBR) in solution comprising a ruthenium compound or a palladium compound or a rhodium compound is subjected to hydrogenation, characterized in that
the amount of ruthenium, based on the at least partially unsaturated nitrile rubber, is 10 ppm to 200 ppm, preferably 10 ppm to 150 ppm, particularly preferably 10 ppm to 120 ppm, very particularly preferably 10 ppm to 79 ppm and most preferably 42 ppm to 79 ppm, or
the amount of palladium, based on the at least partially unsaturated nitrile rubber, is 20 ppm to <67 ppm, preferably 44 ppm to <67 ppm, or
the amount of rhodium, based on the at least partially unsaturated nitrile rubber, is 50 ppm to <270 ppm, preferably 79 ppm to <270 ppm, particularly preferably 50 ppm to 250 ppm, very particularly preferably 50 ppm to 170 ppm and most preferably 79 ppm to 170 ppm.

Hydrogenated nitrile rubbers that have been produced by this method feature improved ageing properties, especially in that the gel content of the crude polymers increases by less than 10% during ageing of the hydrogenated nitrile rubbers for 4 days at 140° C., and also in that the Mooney viscosity increases by less than 40% during ageing of the hydrogenated nitrile rubbers for 4 days at 140° C.

It should be noted at this point that the scope of the invention includes any and all possible combinations of the components, ranges of values and method parameters above and detailed hereinafter, stated in general or within areas of preference.

### Nitrile Rubber (NBR)

The nitrile rubbers (“NBR”) used in the metathesis reaction may be copolymers or terpolymers which comprise repeat units of at least one conjugated diene, at least one α,β-unsaturated nitrile and optionally one or more further copolymerizable monomers.

Any conjugated diene can be used. Preference is given to using (C₄-C₆) conjugated dienes. Particular preference is given to 1,3-butadiene, isoprene, 2,3-dimethylbutadiene, piperylene or mixtures thereof. 1,3-Butadiene and isoprene or mixtures thereof are especially preferred. Very particular preference is given to 1,3-butadiene.

The α,β-unsaturated nitrile used may be any known α,β-unsaturated nitrile, preference being given to (C₃-C₅) α,β-unsaturated nitriles such as acrylonitrile, methacrylonitrile, ethacrylonitrile or mixtures thereof. Particular preference is given to acrylonitrile.

A copolymer of acrylonitrile and 1,3-butadiene is thus a particularly preferred nitrile rubber.

As well as the conjugated diene and the α,β-unsaturated nitrile, it is also possible to use one or more further copolymerizable monomers known to those skilled in the art, e.g. α,β-unsaturated monocarboxylic or dicarboxylic acids or esters or amides thereof. Preferred α,β-unsaturated monocarboxylic or dicarboxylic acids are fumaric acid, maleic acid, acrylic acid and methacrylic acid. Esters of the α,β-unsaturated carboxylic acids used are preferably the alkyl esters and alkoxyalkyl esters thereof. Particularly preferred alkyl esters of the α,β-unsaturated carboxylic acids are methyl acrylate, ethyl acrylate, butyl acrylate, butyl methacrylate, 2-ethylhexyl acrylate, 2-ethylhexyl methacrylate and octyl acrylate. Particularly preferred alkoxyalkyl esters of the α,β-unsaturated carboxylic acids are methoxyethyl (meth)acrylate and ethoxyethyl (meth)acrylate. Use may also be made of mixtures of the abovementioned copolymerizable monomers.

As well as the α,β-ethylenically unsaturated nitrile units and the conjugated diene units, as further copolymerizable monomer, use may be made of a PEG acrylate of the general formula (X)

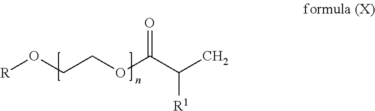

wherein

R is hydrogen or branched or unbranched C₁-C₂₀ alkyl, preferably methyl, ethyl, butyl or ethylhexyl,

n is 1 to 8, preferably 2 to 8, particularly preferably 2 to 5 and very particularly preferably 2 and

R¹ is hydrogen or CH₃₋.

The term “(meth)acrylate” in the context of this invention represents “acrylate” and “methacrylate”. When the R¹ radical in the general formula (I) is CH₃₋, the molecule is a methacrylate.

The term “polyethylene glycol” or the abbreviation “PEG” in the context of this invention represents both monoethylene glycol sections having one repeat ethylene glycol unit (PEG-1; n=1) and polyethylene glycol sections having 2 to 8 repeat ethylene glycol units (PEG-2 to PEG-8; n=2 to 8).

The term “PEG acrylate” is also abbreviated to PEG-X-(M)A where “X” is the number of repeat ethylene glycol units, “MA” is methacrylate and “A” is acrylate.

Acrylate units derived from PEG acrylates of the general formula (I) are referred to in the context of this invention as “PEG acrylate unit”.

Preferred PEG acrylate units are derived from the PEG acrylates of the following formulae no. 1 to no. 10, where n is 1, 2, 3, 4, 5, 6, 7 or 8, preferably 2, 3, 4, 5, 6, 7 or 8, particularly preferably 2, 3, 4 or 5 and very particularly preferably 2:

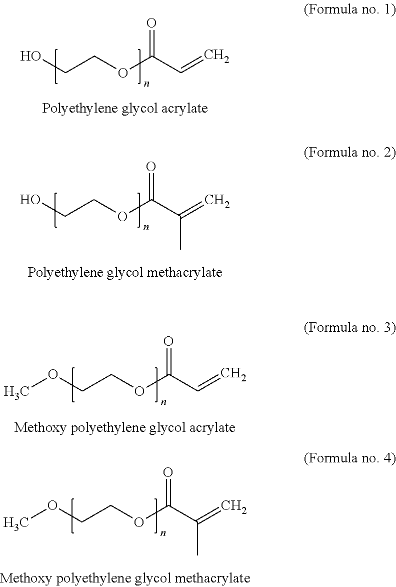

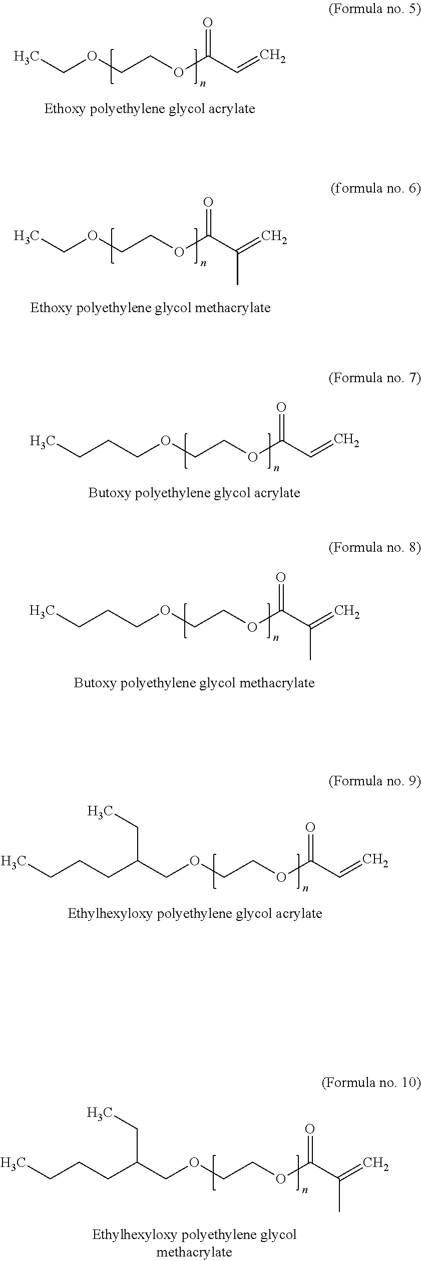

Other commonly used names for methoxy polyethylene glycol acrylate (formula no. 3) are, for example, poly(ethylene glycol) methyl ether acrylate, acryl-PEG, methoxy-PEG acrylate, methoxy poly(ethylene glycol) monoacrylate, poly(ethylene glycol) monomethyl ether monoacrylate or mPEG acrylate.

These PEG acrylates can be purchased commercially, for example from Arkema under the Sartomer® trade name, from Evonik under the Visiomer® trade name or from Sigma Aldrich.

The proportions of conjugated diene and α,β-unsaturated nitrile in the nitrile rubbers to be employed may fluctuate within wide ranges. The proportion of, or of the sum of, the conjugated diene(s) is typically in the range from 40% to 90% by weight, preferably in the range from 55% to 75% by weight, based on the overall polymer. The proportion of, or of the sum of, the α,β-unsaturated nitrile(s) is typically 10% to 60% by weight, preferably 25% to 45% by weight, based on the overall polymer. The proportions of the monomers in each case add up to 100% by weight. The additional monomers may be present in amounts of 0 to 5% by weight, preferably 0.1% to 40% by weight, particularly preferably 1% to 30% by weight, based on the overall polymer. In this case, corresponding proportions of the conjugated diene(s) and/or of the α,β-unsaturated nitrile(s) are replaced by the proportions of the additional monomers, where the proportions of all monomers in each case add up to 100% by weight.

The production of the nitrile rubbers by polymerization, preferably by emulsion polymerization, of the aforementioned monomers is sufficiently well-known to those skilled in the art and extensively described in the polymer literature.

Nitrile rubbers which can be used in the inventive method for hydrogenation are furthermore commercially available, e.g. as products from the product series of the trade names Perbunan® and Krynac® from the company ARLANXEO Deutschland GmbH, of the trade name Nipol® from the company Zeon, of the trade name Europrene® from the company Versalis, of the trade name Nancar® from the company Nantex or of the trade name KNB from the company Kumho.

“At least partially unsaturated nitrile rubber” is understood within the context of this invention to mean nitrile rubber which has free C═C double bonds and is thus unsaturated.

### Metathesis

It is also possible that the production of the nitrile rubber is followed by a metathesis reaction to reduce the molecular weight of the nitrile rubber or a simultaneous metathesis and hydrogenation reaction. Metathesis reactions are sufficiently well-known to those skilled in the art and are described in the literature. Metathesis is known, for example, from WO-A-02/100941 and WO-A-02/100905 and can be used to reduce the molecular weight. The optional method of metathesis degradation is followed by a hydrogenation of the nitrile rubbers.

### Hydrogenation

The invention relates to a method for producing hydrogenated nitrile rubber (HNBR), wherein at least partially unsaturated nitrile rubber (NBR) in solution comprising a ruthenium compound or a palladium compound or a rhodium compound is subjected to hydrogenation, characterized in that
the amount of ruthenium, based on the at least partially unsaturated nitrile rubber, is 10 ppm to 200 ppm, preferably 10 ppm to 150 ppm, particularly preferably 10 ppm to 120 ppm, very particularly preferably 10 ppm to 79 ppm and most preferably 42 ppm to 79 ppm, or
the amount of palladium, based on the at least partially unsaturated nitrile rubber, is 20 ppm to <67 ppm, preferably 44 ppm to <67 ppm, or
the amount of rhodium, based on the at least partially unsaturated nitrile rubber, is 50 ppm to <270 ppm, preferably 79 ppm to <270 ppm, particularly preferably 50 ppm to 250 ppm, very particularly preferably 50 ppm to 170 ppm and most preferably 79 ppm to 170 ppm.

It is possible to conduct the hydrogenation using homogeneous or heterogeneous hydrogenation catalysts. It is also possible to conduct the hydrogenation in situ, i.e. in the same reaction vessel in which the metathesis degradation was also carried out beforehand, and without the need to isolate the degraded nitrile rubber. The hydrogenation catalyst is simply added to the reaction vessel.

The catalysts employed are based on rhodium, ruthenium or palladium (see, for example, U.S. Pat. No. 3,700,637, DE-A-2 539 132, EP-A-0 134 023, DE-OS-35 41 689, EP-A-0 298 386, DE-OS-34 33 392, U.S. Pat. Nos. 4,464,515 and 4,503,196).

Suitable catalysts and solvents for homogeneous-phase hydrogenation are described below and are also known, inter alia, from DE-A-25 39 132 and EP-A-0 471 250.

The hydrogenation of the nitrile rubber to form hydrogenated nitrile rubber using ruthenium compounds such as for example RuHCl(CO)(PPh₃)₃ is known, inter alia, from EP-A-0 213 422, EP-A-0 298 386, EP-A-0 455 154, EP-A-2 072 533, EP-A-2 289 620, EP-A-2 289 621, WO-A-13/159365 and WO-A-14/198022.

Preferred ruthenium compounds for hydrogenating the nitrile rubber to form hydrogenated nitrile rubber are carbonylchlorohydridotris(triphenylphosphine)ruthenium(II), (RuHCl(CO)(PPh₃)₃), benzylidenebis(tricyclohexylphosphine)dichlororuthenium (first-generation Grubbs catalyst), benzylidene[1,3-bis(2,4,6-trimethylphenyl)-2-imidazolidinylidene]dichloro(tricyclohexylphosphine)ruthenium (second-generation Grubbs catalyst), dichloro(o-isopropoxyphenylmethylene)(tricyclohexylphosphine)ruthenium(II) (first-generation Hoveyda-Grubbs catalyst), 1,3-bis(2,4,6-trimethylphenyl)-2-imidazolidinylidene)dichloro(o-isopropoxphenylmethylene)ruthenium (second-generation Hoveyda-Grubbs catalyst) and dichloro(1,3-bis(2,4,6-trimethylphenyl)-2-imidazolidinylidene)((5-((dimethylamino)sulfonyl)-2-(1-methylethoxy-O)phenyl)methylene-C)ruthenium(II) (Zhan catalyst-1B).

The hydrogenation of the nitrile rubber to form hydrogenated nitrile rubber using palladium compounds such as for example palladium acetate is known from Polymer Chemistry A, Volume 30, Issue 3, (1992), pages 471-484 or EP-A-1 454 924.

Palladium compounds that are suitable for hydrogenating the nitrile rubber to form hydrogenated nitrile rubber are palladium complexes having a valency of II or IV that are for example in the form of a salt, a complex or a complex salt. Preferred palladium salts are salts of organic acids, such as palladium acetate and palladium cyanate; halides such as palladium fluoride, palladium chloride, palladium bromide and palladium iodide; oxoacid salts such as palladium nitrate and palladium sulfate; palladium oxide; palladium hydroxide. Preferred palladium complexes and complex salts are dichloro(cyclooctadiene)palladium, dichloro(norbornadiene)palladium, tetrakis(acetonitrile)palladium tetrafluoroborate, tetrakis(benzonitrile)palladium ditetrafluoroborate, dichlorobis(acetonitrile)palladium, dichlorobis(ethylenediamine)palladium, bis(acetylacetonato)palladium, tris(triphenyl-phosphine)acetonitrilepalladium tetrafluoroborate, dichlorobis(triethylphosphine)palladium, dichlorobis(dimethyl sulfide)palladium, dibenzoylsulfidepalladium, bis(2,2′-bipyridine)palladium perchlorate and tetrakis(pyridine)palladium dichloride.

The hydrogenation of the nitrile rubber to form hydrogenated nitrile rubber using rhodium compounds such as for example rhodium acetate [Rh(OAc)₂]₂ or Wilkinson's catalyst [Rh(PPh₃)₃Cl] is, inter alia, known from EP-A-0 213 422 (DE-A-35 29 252), EP-A-0 223 151 (DE-A-35 40 918), EP-A-0 405 266, EP-A-0 482 391, WO-A-02/100905, WO-A-04/035679, WO-A-04035669, WO-A-04/035670, EP-A-1 426 383, EP-A-1 454 924, WO-A-05/068512, WO-A-05/080455, WO-A-05/080456, EP-A-1 705 194, EP-A-1 702 930.

Rhodium compounds that are suitable for hydrogenating the nitrile rubber to form hydrogenated nitrile rubber are halides such as rhodium chloride, rhodium bromide and rhodium iodide; salts of inorganic acids such as rhodium nitrate and rhodium sulfate; salts of organic acids such as rhodium acetate, rhodium formate, rhodium propionate, rhodium butyrate, rhodium valerate and rhodium naphthenate; rhodium oxide, rhodium trihydroxide; and complex compounds such as dichlorobis(triphenylphosphine)rhodium, trichlorotris(pyridine)rhodium, tetrarhodium dodecacarbonyl, dirhodium octacarbonyl, hexarhodium hexadecacarbonyl, rhodium dicarbonyl acetylacetonate, rhodium carbonyl (1-phenylbutane-1,3-dione), tris(hexane-2,4-dione)rhodium, tris(heptane-2,4-dione)rhodium, tris(1-phenylbutane-1,3-dione)rhodium, tris(3-methylpentane-2,4-dione)rhodium and tris(1-cyclohexylbutane-1,3-dione)rhodium.

Preferred rhodium compounds are [Rh(PPh₃)₃Cl] or [Rh(OAc)₂]₂; [Rh(PPh₃)₃Cl] is particularly preferred.

The selective hydrogenation can be achieved, for example, in the presence of a rhodium-or ruthenium-containing catalyst. Use may for example be made of a catalyst of the general formula (R¹ₘB)ₗMXₙ, in which M is ruthenium or rhodium, R¹ are identical or different and are a C₁-C₈ alkyl group, a C₄-C₈ cycloalkyl group, a C₆-C₁₅ aryl group or a C₇-C₁₅ aralkyl group. B is phosphorus, arsenic, sulfur or a sulfoxide group (S═O), X is hydrogen or an anion, preferably halogen and particularly preferably chlorine or bromine, l is 2, 3 or 4, m is 2 or 3 and n is 1, 2 or 3, preferably 1 or 3. Preferred catalysts are tris(triphenylphosphine)rhodium(I) chloride, tris(triphenylphosphine)rhodium(III) chloride and tris(dimethyl sulfoxide)rhodium(III) chloride, and also tetrakis(triphenylphosphine)rhodium hydride of the formula ((C₆H₅)₃P)₄RhH and the corresponding compounds in which the triphenylphosphine has been replaced fully or partly by tricyclohexylphosphine. The catalyst can be used in small amounts. An amount in the range from 0.01% to 1% by weight, preferably in the range from 0.03% to 0.5% by weight and particularly preferably in the range from 0.1% to 0.3% by weight, based on the weight of the polymer, is suitable.

It is typically advisable to use the catalyst together with a co-catalyst which is a ligand of the formula R¹mB, wherein R¹, m and B are each as defined above for the catalyst. Preferably, m is 3, B is phosphorus and the R¹ radicals may be the same or different. The co-catalysts preferably have trialkyl, tricycloalkyl, triaryl, triaralkyl, diaryl monoalkyl, diaryl monocycloalkyl, dialkyl monoaryl, dialkyl monocycloalkyl, dicycloalkyl monoaryl or dicycloalkyl monoaryl radicals.

Examples of co-catalysts can be found in U.S. Pat. No. 4,631,315. A preferred co-catalyst is triphenylphosphine. The co-catalyst is used preferably in amounts in a range from 0.3% to 5% by weight, preferably in the range from 0.5% to 4% by weight, based on the weight of the nitrile rubber to be hydrogenated. Preferably, in addition, the weight ratio of the rhodium-containing catalyst to the co-catalyst is in the range from 1:3 to 1:55, preferably in the range from 1:5 to 1:45. Based on 100 parts by weight of the nitrile rubber to be hydrogenated, in a suitable manner, 0.1 to 33 parts by weight of the co-catalyst, preferably 0.5 to 20 and very particularly preferably 1 to 5 parts by weight, especially more than 2 but less than 5 parts by weight, of the co-catalyst are used, based on 100 parts by weight of the nitrile rubber to be hydrogenated.

The practical conduct of this hydrogenation is sufficiently well-known to those skilled in the art, for example from U.S. Pat. No. 6,683,136.

The hydrogenation according to the invention is typically effected at a temperature of 60 to 200° C., preferably at 100 to 150° C. and particularly preferably at 100 to 140° C.

The hydrogenation according to the invention is typically effected at a pressure of 700 000 pascals to 15 000 000 pascals, preferably at 5 000 000 pascals to 10 000 000 pascals.

The hydrogenation according to the invention is typically effected for 1 to 24 hours, preferably for 1.5 to 12 hours and particularly preferably for 2 to 10 hours.

The hydrogenation according to the invention is preferably conducted in an organic solvent, particularly preferably in an organic solvent selected from the group consisting of benzene, toluene, cyclohexane, dimethyl sulfoxide (DMSO), ethylene carbonate (EC), tetrahydrofuran (THF), 1,4-dioxane, monochlorobenzene (MCB), dichlorobenzene (DCB), trichlorobenzene (TCB), monobromobenzene (MBB), dibromobenzene (DBB), tribromobenzene (TBB), methyl ethyl ketone (MEK), N,N-dimethylformamide (DMF), N,N-dimethylacetamide (DMAC), or mixtures thereof, very particularly preferably in methyl ethyl ketone.

In an alternative embodiment, the hydrogenation is effected by contacting the at least partially unsaturated nitrile rubber (NBR) with hydrogen in a solvent such as toluene or monochlorobenzene at a temperature in the range from 60 to 200° C. and a pressure in the range from 700 000 pascals to 15 000 000 pascals for 1 to 24 hours.

Hydrogenation is understood in the context of this invention to mean a conversion of the double bonds present in the starting nitrile rubber to an extent of at least 50%, preferably 70-100%, particularly preferably 80% to 100%.

In the case of use of heterogeneous catalysts, these are typically supported catalysts based on palladium, which is supported, for example, on charcoal, silica, calcium carbonate or barium sulfate.

On completion of the hydrogenation, a hydrogenated nitrile rubber is obtained that has a Mooney viscosity (ML(1+4), 100° C.), measured as per ASTM Standard D 1646, in the range from 10 to 120, preferably from 10 to 100. This corresponds to a weight-average molecular weight Mw in the range from 2000 to 400 000 g/mol, preferably in the range from 20 000 to 400 000. The hydrogenated nitrile rubbers obtained also have a polydispersity PDI=Mw/Mn, where Mw is the weight-average and Mn the number-average molecular weight, in the range from 1.0 to 6.0, preferably in the range from 2.0 to 5.0 and particularly preferably in the range from 3.0 to 4.5.

### Method for Removing Ruthenium, Palladium or Rhodium

Subsequent to the hydrogenation of the nitrile rubber, method steps may be conducted for removing ruthenium, palladium or rhodium from the hydrogenated nitrile rubber.

In one preferred embodiment, the method according to the invention does not comprise any further method step for removing ruthenium, palladium or rhodium by means of ion-exchange resins, for example a resin bed.

In one particularly preferred embodiment, the method according to the invention does not comprise any further method step for removing ruthenium, palladium or rhodium.

### HNBR Compositions

The invention therefore additionally relates to HNBR compositions comprising hydrogenated nitrile rubber (HNBR) and
10 ppm to 200 ppm, preferably 10 ppm to 150 ppm, particularly preferably 10 ppm to 120 ppm, very particularly preferably 10 ppm to 79 ppm and most preferably 42 ppm to 79 ppm of ruthenium, or
20 ppm to <67 ppm, preferably 44 ppm to <67 ppm of palladium, or
50 ppm to <270 ppm, preferably 50 ppm to 250 ppm, particularly preferably 50 to 240 ppm, very particularly preferably 50 ppm to 170 ppm and most preferably 79 ppm to 170 ppm of rhodium,
   based on the hydrogenated nitrile rubber.

In one alternative embodiment, the HNBR composition comprises hydrogenated nitrile rubber and 10 ppm to 200 ppm, preferably 10 ppm to 150 ppm, particularly preferably 10 ppm to 120 ppm, very particularly preferably 10 ppm to 79 ppm and most preferably 42 ppm to 79 ppm of ruthenium, based on the hydrogenated nitrile rubber.

In one alternative embodiment, the HNBR composition comprises hydrogenated nitrile rubber and 20 ppm to <67 ppm, preferably 44 ppm to <67 ppm of palladium, based on the hydrogenated nitrile rubber.

In one alternative embodiment, the HNBR composition comprises hydrogenated nitrile rubber and 50 ppm to <270 ppm, preferably 50 ppm to 250 ppm, particularly preferably 50 ppm to 240 ppm, very particularly preferably 50 ppm to 170 ppm and most preferably 79 ppm to 170 ppm of rhodium, based on the hydrogenated nitrile rubber.

In one preferred embodiment, the HNBR compositions according to the invention are obtainable by means of the method according to the invention.

The advantage of the HNBR compositions according to the invention resides especially in the improved ageing properties, especially in the reduced increase in the gel content and the Mooney viscosity.

The invention thus additionally provides vulcanizable HNBR compositions comprising
(a) HNBR composition according to the invention and
(b) at least one cross-linker, preferably at least one peroxidic compound.

By way of example, the following peroxide compounds are suitable as the at least one peroxidic compound: bis(2,4-dichlorobenzoyl) peroxide, dibenzoyl peroxide, bis(4-chlorobenzoyl) peroxide, 1,1-bis(tert-butylperoxy)-3,3,5-trimethylcyclohexane, tert-butyl perbenzoate, 2,2-bis(tert-butylperoxy)butene, 4,4-di-tert-butyl peroxynonylvalerate, dicumyl peroxide, 2,5-dimethyl-2,5-di(tert-butylperoxy)hexane, tert-butyl cumyl peroxide, 1,3-bis(tert-butylperoxyisopropyl)benzene, di-tert-butyl peroxide, 2,5-dimethyl-2,5-di(tert-butylperoxy)hexyne, tert-butyl hydroperoxide, hydrogen peroxide, methyl ethyl ketone peroxide, lauroyl peroxide, decanoyl peroxide, 3,5,5-trimethylhexanoyl peroxide, di(2-ethylhexyl) peroxydicarbonate, poly(tert-butyl peroxycarbonate), ethyl 3,3-di(tert-butylperoxy)butyrate, ethyl 3,3-di(tert-amylperoxy)butyrate, n-butyl 4,4-di(tert-butylperoxy)valerate, 2,2-di(tert-butylperoxy)butane, 1,1-di(tert-butylperoxy)cyclohexane, 3,3,5-trimethylcyclohexane, 1,1-di(tert-amylperoxy)cyclohexane, tert-butyl peroxybenzoate, tert-butyl peroxyacetate, tert-butyl peroxy-3,5,5-trimethylhexanoate, tert-butyl peroxyisobutyrate, tert-butyl peroxy-2-ethylhexanoate, tert-butyl peroxypivalate, tert-amyl peroxypivalate, tert-butyl peroxyneodecanoate, cumyl peroxyneodecanoate, 3-hydroxy-1,1-dimethylbutyl peroxyneodecanoate, tert-butyl peroxybenzoate, tert-butyl peroxyacetate, tert-amyl peroxy-3,5,5-trimethylhexanoate, tert-butyl peroxyisobutyrate, tert-butyl peroxy-2-ethylhexanoate, cumyl peroxyneodecanoate, 3-hydroxy-1,1-dimethylbutyl peroxyneodecanoate, 2,5-dimethyl-2,5-di(tert-butylperoxy)hexyne 3-di-tert-amyl peroxide, 2,5-dimethyl-2,5-di(tert-butylperoxy)hexane, tert-amyl hydroperoxide, cumene hydroperoxide, 2,5-dimethyl-2,5-di(hydroperoxy)hexane, diisopropylbenzene monohydroperoxide and potassium peroxodisulfate.

The at least one peroxidic compound in the vulcanizable HNBR composition according to the invention is preferably an organic peroxide, particularly preferably dicumyl peroxide, tert-butyl cumyl peroxide, di(tert-butylperoxyisopropyl)benzene, di-tert-butyl peroxide, 2,5-dimethylhexane 2,5-dihydroperoxide, 2,5-dimethylhex-3-yne 2,5-dihydroperoxide, dibenzoyl peroxide, bis(2,4-dichlorobenzoyl) peroxide, tert-butyl perbenzoate, butyl 4,4-di(tert-butylperoxy)valerate and/or 1,1-bis(tert-butylperoxy)-3,3,5-trimethylcyclohexane, and very particularly preferably di(tert-butylperoxyisopropyl)benzene.

The peroxidic compound is present in the vulcanizable HNBR compositions according to the invention preferably in an amount of 1 to 20 parts by weight, particularly preferably in an amount of 2 to 10 parts by weight, based on 100 parts by weight of the hydrogenated nitrile rubber.

In addition, the vulcanizable HNBR composition may comprise further rubber additives. Standard rubber additives include, for example: polymers not covered by the inventive definition of component (a), fillers, filler activators, processing auxiliaries, oils, especially processing oils, mineral oils or extender oils, plasticizers, accelerators, multifunctional cross-linkers, ageing stabilizers, reversion stabilizers, light stabilizers, antiozonants, antioxidants, mould release agents, retarders, tackifiers, blowing agents, stabilizers, dyes, pigments, waxes, resins, extenders, fillers, for example barium sulfate, titanium dioxide, zinc oxide, calcium oxide, calcium carbonate, magnesium oxide, aluminium oxide, iron oxide, aluminium hydroxide, magnesium hydroxide, aluminium silicates, diatomaceous earth, talc, kaolins, bentonites, carbon nanotubes, graphene, Teflon (the latter preferably in powder form), silicates, carbon blacks, silicas, pyrogenic silica, silica, silanized silica, natural products, for example alumina, kaolins, wollastonite, organic acids, vulcanization retarders, metal oxides, fibres comprising organic and inorganic fibres made of glass, cords, fabric, fibres made of aliphatic and aromatic polyamides (Nylon®, Aramid®), polyesters and natural fibre products, and also fibre pulps, vulcanization activators, additional polymerizable monomers, dimers, trimers or oligomers, salts of unsaturated carboxylic acids, for example zinc diacrylate (ZDA), zinc methacrylates (ZMA) and zinc dimethacrylate (ZDMA), liquid acrylates or other additives known in the rubber industry (Ullmann's Encyclopedia of Industrial Chemistry, VCH Verlagsgesellschaft mbH, D-69451 Weinheim, 1993, vol. A 23 “Chemicals and Additives”, pp. 366-417).

### Method for Producing a Vulcanizable HNBR Composition Comprising HNBR Composition According to the Invention

The invention further provides a method for producing a vulcanizable composition comprising an HNBR composition according to the invention by mixing the HNBR composition according to the invention with at least one cross-linker, preferably at least one peroxidic cross-linker, and the other components optionally present. This mixing operation may be performed in any mixing units customary in the rubber industry, for example internal mixers, Banbury mixers or rollers. The sequence of metered addition may be readily determined by those skilled in the art through suitable experiments.

By way of example, two variants for the possible procedure are described hereinafter:

### Method A: Production in an Internal Mixer

Preference is given to internal mixers with intermeshing rotor geometry.

At the start time, the internal mixer is charged with the HNBR composition according to the invention in bale form, and the bales are comminuted. After a suitable mixing period, the fillers and additives are added. The mixing is effected under temperature control, with the proviso that the mixture remains at a temperature in the range from 80° C. to 150° C. for a suitable time. After a further suitable mixing period, the further mixture constituents are added, such as optionally stearic acid, antioxidants, plasticizers, white pigments (for example titanium dioxide), dyes and other processing actives. After a further suitable mixing period, the internal mixer is vented and the shaft is cleaned. After a further suitable period, the internal mixer is emptied to obtain the vulcanizable mixture. Suitable periods are understood to mean a few seconds to a few minutes. The cross-linking chemicals may either be incorporated by mixing in a separate step on a roller, especially when mixing is performed at an elevated mixing temperature, or co-added directly in the internal mixer. It must be ensured in this case that the mixing temperature is below the reaction temperature of the cross-linking chemicals.

The vulcanizable mixtures thus produced can be assessed in a customary manner, for instance by Mooney viscosity, by Mooney scorch or by a rheometer test.

### Method B: Production on a Roller

If rollers are used as mixing units, the HNBR composition according to the invention is first applied to the roller. Once a homogeneous milled sheet has been formed, the fillers, plasticizers and other additives with the exception of the cross-linking chemicals are added. After incorporation of all components by mixing, the cross-linking chemicals are added and incorporated by mixing. The mixture is then incised three times on the right and three times on the left and doubled over 5 times. The finished milled sheet is rolled to the desired thickness and subjected to further processing according to the desired test methods.

### Method for Producing Vulcanizates Based on Vulcanizable HNBR Compositions According to the Invention

The invention further provides the method for producing vulcanizates, preferably as mouldings, based on vulcanizable HNBR compositions according to the invention (vulcanization), characterized in that the vulcanizable HNBR composition according to the invention is subjected to a vulcanization, preferably in a shaping process and further preferably at temperatures in the range from 100° C. to 250° C., particularly preferably at temperatures in the range from 120° C. to 250° C. and very particularly preferably temperatures in the range from 130° C. to 250° C. To this end, the vulcanizable compositions are subjected to further processing with calenders, rollers or extruders. The preformed mass is then vulcanized in presses, autoclaves, hot air systems or in what are called automatic mat vulcanization systems (“Auma”), and preferred temperatures have been found to be in the range from 100° C. to 250° C., particularly preferred temperatures in the range from 120° C. to 250° C. and very particularly preferred temperatures in the range from 130° C. to 250° C. The vulcanization time is typically 1 minute to 24 hours and preferably 2 minutes to 1 hour. Depending on the shape and size of the vulcanizates, a second vulcanization by reheating may be necessary in order to achieve complete vulcanization.

The invention further provides the thus obtainable vulcanizates, based on vulcanizable HNBR compositions according to the invention.

The invention also provides for the use of the HNBR composition according to the invention for production of mouldings selected from the group consisting of belts, seals, rollers, shoe components, hoses, damping elements, stators and cable sheaths, preferably belts and seals.

The invention thus provides vulcanizates based on vulcanizable HNBR compositions according to the invention that are preferably selected from belts, seals, rollers, shoe components, hoses, damping elements, stators and cable sheaths, particularly preferably belts and seals. The methods usable by way of example for this purpose, such as moulding, injection moulding or extrusion methods, and the corresponding injection moulding apparatuses or extruders, are sufficiently well-known to those skilled in the art.

In the production of these mouldings, it is possible to supplement the hydrogenated nitrile rubber according to the invention with the standard auxiliaries which are known to those skilled in the art and can be suitably selected by them by using customary technical knowledge, for example fillers, filler activators, accelerators, cross-linkers, antiozonants, antioxidants, processing oils, extender oils, plasticizers, activators or scorch inhibitors.

### EXAMPLES

### Materials Used

| | |
|---|---|
| Therban ® 3627 | hydrogenated nitrile rubber, 36% by weight acrylonitrile units; |
| | Mooney viscosity ML 1 + 4@100° C.: 66; gel content: 0.7%, |
| | noble metal content: 2 ppm of rhodium, <1 ppm of |
| | ruthenium, <1 ppm of palladium; (commercially available |
| | from ARLANXEO Deutschland GmbH) |
| Acetone | propan-2-one (commercially available from Merck) |
| Ethanol | (commercially available from Merck) |
| RuCl₃ | ruthenium trichloride (commercially available from Merck) |
| [RuHCl(CO)(PPh₃)₃] | carbonylchlorohydridotris(triphenylphosphine)ruthenium(II) |
| | (commercially available from Merck) |
| [Pd(OAc)₂]₃ | palladium acetate (commercially available from Merck) |
| [Rh(OAc)₂]₂ | rhodium acetate (commercially available from Merck) |
| [Rh(PPh₃)₃Cl] | chloridotris(triphenylphosphine)rhodium(I); Wilkinson's |
| | catalyst (commercially available from Umicore) |

### Mooney Ageing

In order to assess Mooney ageing, the change in the Mooney viscosity was measured after an exemplary ageing process. The values for the Mooney viscosity (ML1+4@100° C.) are determined in each case by means of a shearing disc viscometer in accordance with ASTM D1646-07. Two test specimens are cut out of the rubber. The specimen to be aged is placed into an air circulation drying cabinet, heated to 140° C., on the middle rack. The specimens remain there for 4 days at 140° C.

The Mooney viscosity is determined on the unaged and the aged specimens. AMV results from the difference in the measured values of the aged and the unaged specimen.

### Gel Content

0.1-0.2 g of the polymer is dispersed, or rather the soluble polymer fractions are dissolved, in approximately 20 ml of methyl ethyl ketone (MEK). After 18 hours, the insoluble dispersed fractions are precipitated by centrifugation (25 000 rpm), the supernatant solvent is decanted, the moist gel remaining is weighed, dried thereafter to constant weight at 60° C. in a vacuum drying cabinet, and weighed again.

The percentage gel content is calculated from the difference in weight between the soluble and the insoluble polymer.

### Performance of Ageing Investigations:

The influence of ruthenium, palladium and rhodium compounds on the ageing of hydrogenated nitrile rubber was investigated. To this end, in Examples 1 to 17, hydrogenated nitrile rubber was dissolved and admixed with ruthenium, palladium or rhodium compounds and aged. Specifically, Therban® 3627 (with a noble metal content of 2 ppm of rhodium, <1 ppm of ruthenium and <1 ppm of palladium) was dissolved in acetone (10%) (exception: [Rh(OAc)₂]₂ was dissolved in ethanol) and admixed with the calculated amount of ruthenium, palladium or rhodium compound. After 2 hours of mixing on a shaker, the solution was plated and dried in a vacuum drying cabinet at 55° C. to constant weight. Subsequently to this, the dried HNBR compositions were aged for 4 days at 140° C.

TABLE 1
Comparison of the results of the gel content and Mooney viscosity
prior to ageing and after ageing for 4 days at 140° C.

| | | Polymer prior to ageing | | | Polymer after ageing | | |
|---|---|---|---|---|---|---|---|
| | | Noble | | | (4 d, 140° C.) | | |
| | | metal | Gel | Mooney | Gel | Mooney | |
| Ex. | | addition | content | viscosity | content | viscosity | ΔMV |
| no. | Noble metal | [ppm] | [%] | [MU] | [%] | [MU] | [MU] |
| 1 | Reference | — | 0.7 | 66 | 4.7 | 81 | 15 |
| 2 | RuHCl(CO)(PPh₃)₃ | 42 | 0.6 | 67 | 5.1 | 78 | 11 |
| 3 | RuHCl(CO)(PPh₃)₃ | 79 | 0.6 | 68 | 7.0 | 82 | 14 |
| 4 | RuHCl(CO)(PPh₃)₃ | 120 | 0.6 | 69 | 7.7 | 80 | 11 |
| 5 | RuHCl(CO)(PPh₃)₃ | 150 | 0.8 | 69 | 4.2 | 79 | 10 |
| 6 | RuHCl(CO)(PPh₃)₃ | 200 | 0.8 | 69 | 5.2 | 78 | 8 |
| 7 | Pd(OAc)₂ | 44 | 0.8 | 68 | 9.2 | 91 | 23 |
| 8 | Pd(OAc)₂ | 67 | 0.9 | 68 | 11.2 | 83 | 15 |
| 9 | Pd(OAc)₂ | 100 | 0.5 | 69 | 12.6 | 105 | 36 |
| 10 | Pd(OAc)₂ | 120 | 0.5 | 69 | 16.7 | 129 | 60 |
| 11 | Pd(OAc)₂ | 150 | 0.8 | 68 | 17.1 | 115 | 47 |
| 12 | Pd(OAc)₂ | 210 | 0.7 | 76 | 17.6 | 174 | 99 |
| 13 | [Rh(OAc)₂]₂ | 79 | 0.7 | 67 | 4.2 | 88 | 22 |
| 14 | [Rh(OAc)₂]₂ | 170 | 0.8 | 67 | 5.5 | 91 | 24 |
| 15 | [Rh(OAc)₂]₂ | 240 | 0.9 | 67 | 5.6 | 99 | 32 |
| 16 | [Rh(OAc)₂]₂ | 270 | 0.8 | 66 | 8.0 | 106 | 41 |
| 17 | [Rh(OAc)₂]₂ | 280 | 0.7 | 66 | 6.5 | 108 | 41 |

Ruthenium compounds have only a small influence on the ageing of the hydrogenated nitrile rubber in a range from 10 ppm to 200 ppm. After 4 days of ageing at 140° C., the gel content is below 10% and the increase in the Mooney viscosity is less than 20 MU.

Palladium compounds have only a small influence on the ageing of the hydrogenated nitrile rubber in a range from 20 ppm to <67 ppm. After 4 days of ageing at 140° C., the gel content is below 10% and the increase in the Mooney viscosity is less than 40 MU. If the content of palladium in the HNBR is 100 ppm or more, there is a marked increase in gel formation over the course of the ageing and also in the amount by which the Mooney viscosity rises.

Rhodium compounds have only a small influence on the ageing of the hydrogenated nitrile rubber in a range from 50 ppm to <270 ppm. After 4 days of ageing at 140° C., the gel content is below 10% and the increase in the Mooney viscosity is less than 40 MU. If the content of rhodium in the HNBR is 270 ppm or more, there is a marked increase in the amount by which the Mooney viscosity rises.

1. Method for producing hydrogenated nitrile rubber (HNBR) comprising repeat units of at least 40% to 90% by weight of a conjugated diene and at least 10% to 60% by weight of an α,β-unsaturated nitrile,
comprising subjecting at least partially unsaturated nitrile rubber (NBR) in solution comprising a ruthenium compound or a palladium compound or a rhodium compound to hydrogenation, wherein:
the amount of ruthenium, based on the at least partially unsaturated nitrile rubber, is 10 ppm to 200 ppm, 10 ppm to 150 ppm, 10 ppm to 120 ppm, 10 ppm to 79 ppm, or preferably 42 ppm to 79 ppm, or
the amount of palladium, based on the at least partially unsaturated nitrile rubber, is 20 ppm to <67 ppm or 44 ppm to <67 ppm, or
the amount of rhodium, based on the at least partially unsaturated nitrile rubber, is 50 ppm to <270 ppm, 79 ppm to <270 ppm, 50 ppm to 250 ppm, 50 ppm to 170 ppm, and or 79 ppm to 170 ppm,
wherein the hydrogenation is effected at a temperature of 60 to 200° C., at a pressure of 700 000 pascals to 15 000 000 pascals, and for a period of 1 to 24 hours,
wherein the ruthenium compounds are selected from the group consisting of carbonylchlorohydridotris(triphenylphosphine)ruthenium(II), (RuHCl(CO)(PPh₃)₃), benzylidenebis(tricyclohexylphosphine)dichlororuthenium (first-generation Grubbs catalyst), benzylidene[1,3-bis(2,4,6-trimethylphenyl)-2-imidazolidinylidene]dichloro(tricyclohexylphosphine)ruthenium (second-generation Grubbs catalyst), dichloro(o-isopropoxyphenylmethylene)(tricyclohexylphosphine)ruthenium(II) (first-generation Hoveyda-Grubbs catalyst), 1,3-bis(2,4,6-trimethylphenyl)-2-imidazolidinylidene)dichloro(o-isopropoxyphenylmethylene)ruthenium (second-generation Hoveyda-Grubbs catalyst), or dichloro(1,3-bis(2,4,6-trimethylphenyl)-2-imidazolidinylidene)((5-((dimethylamino)sulfonyl)-2-(1-methylethoxy-O)phenyl)methylene-C)ruthenium(II) (Zhan catalyst-1B), or are selected from a compound of the general formula (R¹ₘB)ₗMXₙ, in which M is ruthenium or rhodium, R¹ are identical or different and are a C₁-C₈ alkyl group, a C₄-C₈ cycloalkyl group, a C₆-C₁₅ aryl group or a C₇-C₁₅ aralkyl group. B is phosphorus, arsenic, sulfur or a sulfoxide group (S═O), X is hydrogen or an anion, halogen, chlorine, or bromine, l is 2, 3 or 4, m is 2 or 3 and n is 1, 2 or 3,
wherein the palladium compounds are selected from palladium acetate, palladium cyanate, palladium fluoride, palladium chloride, palladium bromide, palladium iodide, palladium nitrate, palladium sulfate, palladium oxide, palladium hydroxide, dichloro(cyclooctadiene)palladium, dichloro(norbornadiene)palladium, tetrakis(acetonitrile)palladium tetrafluoroborate, tetrakis(benzonitrile)palladium ditetrafluoroborate, dichlorobis(acetonitrile)palladium, dichlorobis(ethylenediamine)palladium, bis(acetylacetonato)palladium, tris(triphenylphosphine)acetonitrilepalladium tetrafluoroborate, dichlorobis(triethylphosphine)palladium, dichlorobis(dimethyl sulfide)palladium, dibenzoylsulfidepalladium, bis(2,2′-bipyridine)palladium perchlorate, or tetrakis(pyridine)palladium dichloride,
wherein the rhodium compounds are selected from rhodium chloride, rhodium bromide, rhodium iodide, rhodium nitrate, rhodium sulfate, rhodium acetate, rhodium formate, rhodium propionate, rhodium butyrate, rhodium valerate, rhodium naphthenate, rhodium oxide, rhodium trihydroxide; dichlorobis(triphenylphosphine)rhodium, trichlorotris(pyridine)rhodium, tetrarhodium dodecacarbonyl, dirhodium octacarbonyl, hexarhodium hexadecacarbonyl, rhodium dicarbonyl acetylacetonate, rhodium carbonyl (1-phenylbutane-1,3-dione), tris(hexane-2,4-dione)rhodium, tris(heptane-2,4-dione)rhodium, tris(1-phenylbutane-1,3-dione)rhodium, tris(3-methylpentane-2,4-dione)rhodium, tris(1-cyclohexylbutane-1,3-dione)rhodium, or [Rh(OAc)₂]₂, or are selected from a compound of the general formula (R¹ₘB)ₗMXₙ, in which M is rhodium, R¹ are identical or different and are a C₁-C₈ alkyl group, a C₄-C₈ cycloalkyl group, or a C₇-C₁₅ aralkyl group, B is phosphorus, arsenic, sulfur or a sulfoxide group (S═O), X is hydrogen or an anion, halogen, chlorine, or bromine, l is 2, 3 or 4, m is 2 or 3 and n is 1, 2 or 3,
and
wherein no step for removing ruthenium, palladium or rhodium takes place after hydrogenation.

2. Method according to claim 1, wherein the hydrogenation is effected at a temperature of 100 to 150° C. or at 100 to 140° C.

3. Method according to claim 1, wherein the hydrogenation is effected at a pressure of 5 000 000 pascals to 10 000 000 pascals.

4. Method according to claim 1, wherein the hydrogenation is effected for a period of 1.5 to 12 hours.

5. Method according to claim 1, wherein the hydrogenation is conducted in an organic solvent or in an organic solvent selected from the group consisting of benzene, toluene, cyclohexane, dimethyl sulfoxide (DMSO), ethylene carbonate (EC), tetrahydrofuran (THF), 1,4-dioxane, monochlorobenzene (MCB), dichlorobenzene (DCB), trichlorobenzene (TCB), monobromobenzene (MBB), dibromobenzene (DBB), tribromobenzene (TBB), methyl ethyl ketone (MEK), N,N-dimethylformamide (DMF), N,N-dimethylacetamide (DMAC), methyl ethyl ketone, or mixtures thereof.

6. HNBR compositions obtainable by the method of claim 1, comprising
hydrogenated nitrile rubber, comprising repeat units of at least 40% to 90% by weight of a conjugated diene and at least 10% to 60% by weight of an α,β-unsaturated nitrile, and
10 ppm to 200 ppm, 10 ppm to 150 ppm, 10 ppm to 120 ppm, 10 ppm to 79 ppm, or 42 ppm to 79 ppm of ruthenium, or
20 ppm to <67 ppm, or 44 ppm to <67 ppm of palladium, or
50 ppm to <270 ppm, 50 ppm to 250 ppm, 50 ppm to 240 ppm, 50 ppm to 170 ppm, or 79 ppm to 170 ppm of rhodium,
based on the hydrogenated nitrile rubber,
wherein the Mooney viscosity (ML(1+4), 100° C.) of the hydrogenated nitrile rubbers, measured as per ASTM Standard D 1646, is in the range from 10 to 120, and the Mooney viscosity increases by less than 40% during ageing of the hydrogenated nitrile rubbers for 4 days at 140° C., and wherein the hydrogenated nitrile rubbers obtained have a polydispersibility PDI 0 Mw7Mn, where Mw is the weight-average and Mn the number-average molecular weight, in a range of from 1 to 6.

7. Vulcanizable HNBR composition comprising
(a) HNBR composition according to claim 6 and
(b) at least one cross-linker, or at least one peroxidic compound.

8. Method for producing vulcanizable a HNBR compositions according to claim 7 comprising mixing an HNBR composition with at least one cross-linker, or a peroxidic compound, wherein the HNBR composition comprises
hydrogenated nitrile rubber, comprising repeat units of at least 40% to 90% by weight of a conjugated diene and at least 10% to 60% by weight of an α,β-unsaturated nitrile, and
10 ppm to 200 ppm, 10 ppm to 150 ppm, 10 ppm to 120 ppm, 10 ppm to 79 ppm, or 42 ppm to 79 ppm of ruthenium, or
20 ppm to <67 ppm or 44 ppm to <67 ppm of palladium, or
50 ppm to <270 ppm, 50 ppm to 250 ppm, 50 ppm to 240 ppm, 50 ppm to 170 ppm, or 79 ppm to 170 ppm of rhodium,
based on the hydrogenated nitrile rubber,
wherein the Mooney viscosity (ML(1+4), 100° C.) of the hydrogenated nitrile rubbers, measured as per ASTM Standard D 1646, is in the range from 10 to 120, and the Mooney viscosity increases by less than 40% during ageing of the hydrogenated nitrile rubbers for 4 days at 140° C., and wherein the hydrogenated nitrile rubbers obtained have a polydispersibility PDI 0 Mw7Mn, where Mw is the weight-average and Mn the number-average molecular weight, in a range of from 1 to 6.

9. Method for producing vulcanizates, comprising subjecting the vulcanizable HNBR composition according to claim 7 to a vulcanization, in a shaping process and at temperatures in the range from 100° C. to 250° C., from 120° C. to 250° C., or from 130° C. to 250° C.

10. Vulcanizates based on a vulcanizable HNBR compositions according to claim 7, obtainable by subjecting the vulcanizable HNBR composition to a vulcanization in a shaping process and at temperatures in the range from 100° C. to 250° C., from 120° C. to 250° C., or from 130° C. to 250° C.

11. Method of producing mouldings selected from the group consisting of belts, seals, rollers, shoe components, hoses, damping elements, stators, cable sheaths, belts, and seals with the HNBR composition according to claim 6.
